(19) United States
(12) Patent Application Publication
(10) Pub. No.: US 2026/0051677 A1
(43) Pub. Date: Feb. 19, 2026

(54) M.2 TO DUAL PCIE X1 SWITCHED ADAPTER ASSEMBLY

(71) Applicant: IXI Technology Holdings, Inc., Yorba Linda, CA (US)

(72) Inventors: Jin Qiao, Yorba Linda, CA (US); David Rodriguez, Ladera Ranch, CA (US); Eileen Lazano, Chino, CA (US); Denes Molnar, Corona, CA (US)

(21) Appl. No.: 18/802,986

(22) Filed: Aug. 13, 2024

(51) Int. Cl. H01R 12/71; G06F 13/42; H01R 12/75

(52) U.S. Cl. CPC H01R 12/716; G06F 13/4221; H01R 12/75; G06F 2213/0026

(57) ABSTRACT

An adapter assembly including an adapter board assembly and an electrical cable connector. The adapter board assembly includes a board member, an upstream PCIe 1× port, a PCIe 1 to 2 switch, a first and a second downstream PCIe 1× port. The board member has a top surface and a bottom surface. The upstream PCIe 1× port is mounted on the board member. The PCIe 1 to 2 switch is mounted on the board member and electrically coupled in bi-directional communication with the upstream PCIe 1× port. The first downstream PCIe 1× port is mounted on the board member, and electrically coupled in bi-directional communication with the PCIe 1 to 2 switch. The second downstream PCIe 1× port is mounted on the board member, and electrically coupled in bi-directional communication with the PCIe 1 to 2 switch. The adapter board assembly may further include a power supply connector.

### CROSS-REFERENCE TO RELATED APPLICATION

NA

### BACKGROUND OF THE DISCLOSURE

### 1. Field of the Disclosure

The disclosure relates in general to adapters for different connections, and more particularly, to a switched adapter for adapting between an M.2 port and a dual PCIe ×1 ports, which enable high-speed data transfer between the M.2 port and two PCIe devices.

### 2. Background Art

Increasingly, M.2 ports are commonly used in computing hardware. Indeed, many newer motherboards and other such boards no longer provide slots other than M.2 ports for high-speed data transfer. Additionally, for some applications, such as small embedded computing systems, it is difficult to find adequate space for multiple PCIe based ports to exist. For such reasons, PCIe ports are used increasingly infrequently.

Yet, there remains a need for the use of PCIe peripherals and/or devices with such computing devices that are supplied solely with M.2 connectors. In some instances, it is desired to use multiple PCIe peripherals and/or devices with current boards. This has proven difficult to accomplish for various reasons.

### SUMMARY OF THE DISCLOSURE

The disclosure is directed to an adapter assembly comprising an adapter board assembly and an electrical cable connector. The adapter board assembly includes a board member, an upstream PCIe 1× port, a PCIe 1 to 2 switch, a first downstream PCIe 1× port and a second downstream PCIe 1× port. The board member has a top surface and a bottom surface. The upstream PCIe 1× port is mounted on the board member. The PCIe 1 to 2 switch is mounted on the board member and electrically coupled in bi-directional communication with the upstream PCIe 1× port. The first downstream PCIe 1× port is mounted on the board member, the first downstream PCIe 1× port electrically coupled in bi-directional communication with the PCIe 1 to 2 switch. The second downstream PCIe 1× port is mounted on the board member, the second downstream PCIe 1× port electrically coupled in bi-directional communication with the PCIe 1 to 2 switch. The electrical cable connector is attachable to the upstream PCIe 1× port.

In some configurations, the electrical cable connector includes a first end, a second end and a connector cable. The first end comprises an M.2 connector. The second end comprises a PCIe connector. The connector cable extends between the first end and the second end and electrically coupling the M.2 connector with the PCIe connector.

In some configurations, the second end of the electrical cable is soldered to the upstream PCIe 1× port.

In some configurations, the second end of the electrical cable is releasably coupled to the upstream PCIe 1× port.

In some configurations, the adapter assembly further comprises a power supply connector structurally configured to receive a power input for at least one of the upstream PCIe 1× port, the PCIe 1 to 2 switch the first downstream PCIe 1× port mounted on the board member and the second downstream PCIe 1× port.

In some such configurations, the power supply connector comprises a 4-pin ATX power connector.

In some configurations, the voltage supplied to the power supply connector comprises 12V.

In some configurations, the adapter assembly further comprises at least one voltage regulator structurally configured to convert a voltage from the power supply connector to at least a second voltage.

In some configurations, the upstream PCIe 1× port is mounted on a top surface of the board member, with the first downstream PCIe 1× port and the second PCIe 1× port being mounted on a bottom surface of the board member, with the bottom surface being opposite the top surface.

In some configurations, the PCIe 1 to 2 switch is mounted on the top surface of the board member.

In some configurations, the board member comprises a substantially rectangular outer perimeter having two long sides and two short sides.

In some configurations, the upstream PCIe 1× portion is mounted proximate the outer perimeter along one of the two long sides.

In some configurations, the first downstream PCIe 1× port and the second downstream PCIe 1× port are positioned in a spaced apart orientation on the bottom surface of the board member.

In some configurations, the first downstream PCIe 1× port and the second downstream PCIe 1× port are oriented so as to be substantially parallel to each other in a spaced apart orientation.

In some configurations, the upstream PCIe 1× port is oriented so as to be substantially parallel to each of the first downstream PCIe 1× port and the second downstream PCIe 1× port.

In another aspect of the disclosure, the disclosure is directed to an adapter board assembly which includes a board member, an upstream PCIe 1× port, a PCIe 1 to 2 switch, a first downstream PCIe 1× port and a second downstream PCIe 1× port. The board member has a top surface and a bottom surface. The upstream PCIe 1× port is mounted on the board member. The PCIe 1 to 2 switch mounted on the board member and electrically coupled in bi-directional communication with the upstream PCIe 1× port. The first downstream PCIe 1× port mounted on the board member, the first downstream PCIe 1× port electrically coupled in bi-directional communication with the PCIe 1 to 2 switch. The second downstream PCIe 1× port mounted on the board member, the second downstream PCIe 1× port electrically coupled in bi-directional communication with the PCIe 1 to 2 switch.

In some configurations, the upstream PCIe 1× port is mounted on a top surface of the board member, with the first downstream PCIe 1× port and the second PCIe 1× port being mounted on a bottom surface of the board member, with the bottom surface being opposite the top surface.

In some configurations, the PCIe 1 to 2 switch is mounted on the top surface of the board member.

In some configurations, the first downstream PCIe 1× port and the second downstream PCIe 1× port are oriented so as to be substantially parallel to each other in a spaced apart orientation, with the upstream PCIe 1× port oriented so as to be substantially parallel to each of the first downstream PCIe 1× port and the second downstream PCIe 1× port.

In yet another aspect of the disclosure, the disclosure is directed to a method of using the adapter assembly disclosed herein, the method comprising the steps of: providing the adapter board assembly; providing the electrical cable connector; a connector cable extending between the first end and the second end and electrically coupling the M.2 connector with the PCIe connector; connecting the first end to an existing M.2 port on a computing device; and connecting the second end to the upstream PCIe 1× port of the adapter board assembly.

In some configurations, the method further includes the step of: attaching the adapter board assembly to the existing computing device.

In some configurations, the method further includes the step of: attaching a first PCIe device to one of the first downstream 1× PCIe port and the second downstream 1× PCIe port.

In some configurations, the method further includes the step of: attaching a second PCIe device to another of the first downstream 1× PCIe port and the second downstream 1× PCIe port.

In some configurations, the first PCIe device and the second PCIe device are connected to the adapter board assembly simultaneously.

In some configurations, the adapter board assembly further includes a power supply connector. In turn, the method further includes the step of connecting a power supply to a power supply connector.

### BRIEF DESCRIPTION OF THE DRAWINGS

The disclosure will now be described with reference to the drawings wherein:

FIG. 1 of the drawings is a schematic representation of the adapter assembly of the present disclosure, showing, in particular, the attachment of a first and second PCIe device, as well as attachment to an M.2 port of an existing computing device or outside structure;

FIG. 2 of the drawings is a top plan view of a configuration of the adapter board assembly of the present disclosure; and

FIG. 3 of the drawings is a bottom plan view of a configuration of the adapter board assembly of the present disclosure.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

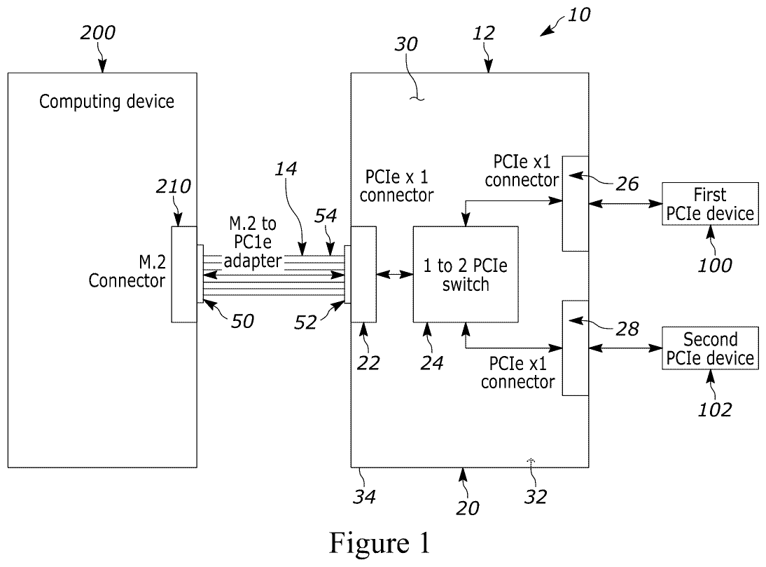

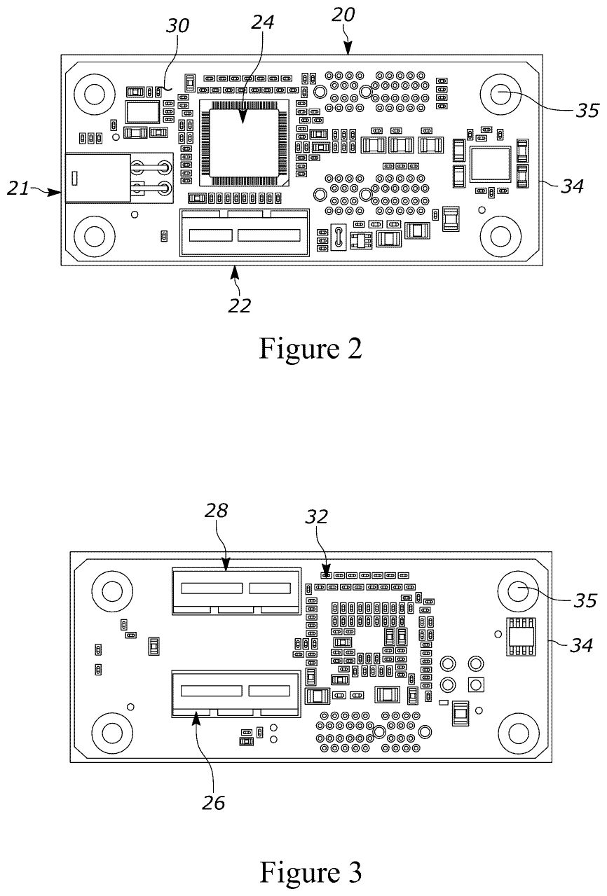

Referring now to the drawings and in particular to FIG. 1, the M.2 to dual PCIe ×1 switched adapter assembly (hereinafter often referred to as adapter assembly) is shown generally at 10. The adapter assembly is configured for use in association with various hardware devices 200 (i.e., computers, tablets, specialty hardware, among others) that utilize motherboards (or daughterboards) having an M.2 type connector 210. It is contemplated that the present adapter assembly is configured to communicate with an M.2, M Key or an M.2, E Key connector, without limitation.

The adapter assembly is shown as comprising adapter board assembly 12 and electrical cable connector 14. In the configuration shown, the electrical cable connector 14 is releasably attachable to the adapter board assembly 12. In other configurations, the electrical cable connector has a more permanent (that is, not intended to be separated in normal operation) connection with the adapter board assembly 12.

The adapter board assembly 12 includes board member 20, power supply connector 21, upstream PCIe 1× port 22; PCIe 1 to 2 switch 24, first downstream PCIe 1× port 26, second downstream PCIe 1× port 28. In the configuration shown, the board member 20 comprises top surface 30, bottom surface 32 which define a board of a substantially uniform thickness. In the configuration shown, the board member 20 defines a generally uniform rectangular perimeter (which may be chamfered at the corners). A plurality of openings, such as openings, such as opening 35, are disposed proximate the corners of the board member 20 so as to facilitate coupling to other structures (i.e., a housing, another board, among others).

In the configuration shown, due to the requirements of the board generally being in excess of the power supplied by the M.2 connector, power supply connector 21 is provided. The power supply connector 21, in the configuration shown comprises a 4-pin ATX power connector. The power connector is configured to receive +12V which can then be converted by voltage regulators on the board to the desired voltages for the PCIe 1 to 2 Switch as well as the other circuitry of the adapter assembly (i.e., to a second voltage that is other than the received voltage). It will be understood that other voltages are contemplated, as well as other types of connectors. Advantageously, the power in the present disclosure is provided directly to the board through the power supply connector 21.

The upstream PCIe 1× port 22 is mounted on top surface 30 proximate an edge thereof, and more particularly on a longer of the rectangular sides of the board. In other configurations, the upstream PCIe 1× port 22 may be mounted away from an edge, or along another edge. The PCIe 1 to 2 switch 24 is positioned on the top surface 30 spaced apart from the PCIe 1× port 22, and is electrically coupled to the upstream PCIe 1× port 22 in bi-directional communication. In other configurations, the PCIe 1 to 2 switch 24 may be positioned on the bottom surface 32 of the board member 20. While not being limited thereto, one such PCIe 1 to 2 switch comprises model number P17C9X2G304SL sold by Diodes Incorporated of Plano, Texas.

The first downstream PCIe 1× port 26 is mounted on bottom surface 32 of the board member 20, and electrically coupled to the PCIe 1 to 2 switch 24 in bi-directional communication. Similarly, the second downstream PCIe 1× port 28 is mounted on bottom surface 32 of the board member 20, and electrically coupled to the PCIe 1 to 2 switch 24 in bi-directional communication. It will be understood that the PCIe 1 to 2 switch 24 controls the communication between the downstream and upstream. Furthermore, as will be understood to one of ordinary skill in the art, additional circuitry is positioned on the top surface 30 and/or the bottom surface 32 of the board member 20 so as to support the PCIe 1 to 2 switch 24 and to provide proper and desired power to the first downstream PCIe 1× port 26 and the second downstream PCIe 1× port 28. Power may be supplied to the board through any number of known configurations, including but not limited to power provided directly from a power supply, or indirectly from another board, or component.

It will be understood that different positions and orientations are contemplated for any one of the upstream PCIe 1× port 22, the PCIe 1 to 2 switch 24, the first downstream PCIe 1× port 26 and the second downstream PCIe 1× port 28. In the configuration shown, the first and second downstream ports are positioned in a side by side spaced apart orientation. Of course, the configuration is not limited thereto, however, such a configuration provides ease of attachment and uniform positioning which may be preferred or desired. In the configuration shown, the downstream ports are positioned so that they are directed to the longer of the sides of the board member 20. It is contemplated that both ports may face the same direction, or they may face opposite directions. In still other configurations, they may face orthogonal directions or may be oblique to each other. It will further be understood that the downstream and upstream ports may all be parallel to each other, or may be perpendicular or oblique to each other in different configurations.

It will be understood that the first downstream PCIe 1× port 26 and the second downstream PCIe 1× port 28 may be coupled to outside devices which may range from any number of peripherals that utilize a PCIe 1× connector. This my include, for example hard drives, ssd drives, network cards, GPU's capture cards, peripherals, controller cards, among others. Two such devices are shown schematically as first PCIe device 100 and second PCIe device 102. First PCIe device 100 is electrically coupled in bi-directional communication to the first downstream PCIe 1× port 26. Second PCIe device 102 is electrically coupled in bi-directional communication to the second downstream PCIe 1× port 28.

The electrical cable connector 14 is shown as comprising first end 50, second end 52 and connector cable 54. The first end 50 terminates with an M.2 connector, and in the configuration shown, a male M.2 connector. The second end 52 terminates with a PCIe 1× connector, and in the configuration shown, a female PCIe 1× connector. It will be understood that in some configurations, the upstream PCIe 1× port 22 and the second end 52 may be soldered together, such that they are generally not intended to be separable. In other configurations, it is contemplated that the male and female connections may be swapped for any of the different connectors. The connector cable 54 may comprise a conventionally known ribbon having a plurality of conductors extending thereacross, generally arranged in parallel (with and without twisting). In some configurations, the electrical cable connector may comprise an M.2 Key A.E. to PCIe ×1 extension cable offered by ADT-LINK of New Taipei, Taiwan under part number R51SS.

In operation, a user is provided with the adapter assembly 10. The adapter board assembly 12 may be coupled to an existing piece of hardware, such as a motherboard, a daughterboard, a housing, among others. The adapter board assembly, once assembled, is configured to be attached to an existing M.2 connector which may be mounted on a motherboard, a daughterboard or the like. To electrically couple the two, the electrical cable connector 14 is provided. The first end 50 thereof is attached to the M.2 port outside of the assembly, while the second end 52 is coupled to the upstream PCIe 1× port 22.

Next, the first PCIe device 100 and the second PCIe device 102 are provided. The first PCIe device 100 is coupled to the first downstream PCIe 1× port 26 and the second PCIe device 102 is coupled to the second downstream PCIe 1× port 28. The adapter assembly is now ready for use.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. An adapter assembly comprising:
an adapter board assembly including:
board member having a top surface and a bottom surface;
an upstream PCIe 1× port mounted on the board member;
a PCIe 1 to 2 switch mounted on the board member and electrically coupled in bi-directional communication with the upstream PCIe 1× port;
a first downstream PCIe 1× port mounted on the board member, the first downstream PCIe 1× port electrically coupled in bi-directional communication with the PCIe 1 to 2 switch; and
a second downstream PCIe 1× port mounted on the board member, the second downstream PCIe 1× port electrically coupled in bi-directional communication with the PCIe 1 to 2 switch; and
an electrical cable connector attachable to the upstream PCIe 1× port.

2. The adapter assembly of claim 1 wherein the electrical cable connector includes:
a first end comprising an M.2 connector;
a second end comprising a PCIe connector; and
a connector cable extending between the first end and the second end and electrically coupling the M.2 connector with the PCIe connector.

3. The adapter assembly of claim 2 wherein the second end of the electrical cable is soldered to the upstream PCIe 1× port.

4. The adapter assembly of claim 2 wherein the second end of the electrical cable is releasably coupled to the upstream PCIe 1× port.

5. The adapter assembly of claim 1 further comprising a power supply connector structurally configured to receive a power input for at least one of the upstream PCIe 1× port, the PCIe 1 to 2 switch the first downstream PCIe 1× port mounted on the board member and the second downstream PCIe 1× port.

6. The adapter assembly of claim 5 wherein the power supply connector comprises a 4-pin ATX power connector.

7. The adapter assembly of claim 6 wherein the voltage supplied to the power supply connector comprises 12V.

8. The adapter assembly of claim 5 further comprising at least one voltage regulator structurally configured to convert a voltage from the power supply connector to at least a second voltage.

9. The adapter assembly of claim 1 wherein the upstream PCIe 1× port is mounted on the top surface of the board member, with the first downstream PCIe 1× port and the second PCIe 1× port being mounted on the bottom surface of the board member, with the bottom surface being opposite the top surface.

10. The adapter assembly of claim 5 wherein the PCIe 1 to 2 switch is mounted on the top surface of the board member.

11. The adapter assembly of claim 10 wherein the board member comprises a substantially rectangular outer perimeter having two long sides and two short sides.

12. The adapter assembly of claim 11 wherein the upstream PCIe 1× portion is mounted proximate the outer perimeter along one of the two long sides.

13. The adapter assembly of claim 9 wherein the first downstream PCIe 1× port and the second downstream PCIe 1× port are positioned in a spaced apart orientation on the bottom surface of the board member.

14. The adapter assembly of claim 13 wherein the first downstream PCIe 1× port and the second downstream PCIe 1× port are oriented so as to be substantially parallel to each other in a spaced apart orientation.

15. The adapter assembly of claim 14 wherein the upstream PCIe 1× port is oriented so as to be substantially parallel to each of the first downstream PCIe 1× port and the second downstream PCIe 1× port.

16. An adapter board assembly including:
board member having a top surface and a bottom surface;
an upstream PCIe 1× port mounted on the board member;
a PCIe 1 to 2 switch mounted on the board member and electrically coupled in bi-directional communication with the upstream PCIe 1× port;
a first downstream PCIe 1× port mounted on the board member, the first downstream PCIe 1× port electrically coupled in bi-directional communication with the PCIe 1 to 2 switch; and
a second downstream PCIe 1× port mounted on the board member, the second downstream PCIe 1× port electrically coupled in bi-directional communication with the PCIe 1 to 2 switch.

17. A method of using the adapter assembly of claim 16 comprising the steps of:
providing the adapter board assembly;
providing the electrical cable connector, the electrical cable connector further including:
a first end comprising an M.2 connector;
a second end comprising a PCIe connector;
a connector cable extending between the first end and the second end and electrically coupling the M.2 connector with the PCIe connector;
connecting the first end to an existing M.2 port on a computing device; and
connecting the second end to the upstream PCIe 1× port of the adapter board assembly.

18. The method of claim 17 further comprising the step of:
attaching the adapter board assembly to the existing computing device.

19. The method of claim 18 further comprising the step of:
attaching a first PCIe device to one of the first downstream 1× PCIe port and the second downstream 1× PCIe port.

20. The method of claim 19 further comprising the step of:
attaching a second PCIe device to another of the first downstream 1× PCIe port and the second downstream 1× PCIe port.

21. The method of claim 20 wherein the first PCIe device and the second PCIe device are connected to the adapter board assembly simultaneously.

22. The method of claim 17 wherein the adapter board assembly further includes a power supply connector, the method further comprising the step of:
connecting a power supply to a power supply connector.
